(19) United States
(12) Patent Application Publication
(10) Pub. No.: US 2021/0012267 A1
(43) Pub. Date: Jan. 14, 2021

(54) FILTERING RECOMMENDATIONS

(71) Applicant: Microsoft Technology Licensing, LLC, Redmond, WA (US)

(72) Inventors: Nadia Fawaz, Sunnyvale, CA (US); Nikhil N. Jannu, Bengaluru (IN); Feng Guo, Los Gatos, CA (US); Somya Gupta, Bengaluru (IN); Uma K. Sawant, Bengaluru (IN); Praveen Sampath, Bengaluru (IN); Janani Sriram, Bengaluru (IN); Liang Zhang, Fremont, CA (US)

(73) Assignee: Microsoft Technology Licensing, LLC, Redmond, WA (US)

(21) Appl. No.: 16/505,306

(22) Filed: Jul. 8, 2019

(51) Int. Cl. G06Q 10/06; G06N 5/02; G06F 16/9535; G06N 20/00; G06Q 10/10

(52) U.S. Cl. CPC G06Q 10/063112; G06N 5/025; G06Q 10/1053; G06N 20/00; G06F 16/9535

(57) ABSTRACT

The disclosed embodiments provide a system for processing data. During operation, the system obtains a set of rules for filtering job recommendations, wherein the rules are selected to maximize a reduction in negative outcomes associated with the job recommendations. Next, the system generates a label for a set of candidate-job pairs that match one or more of the rules and inputs the label with a set of candidate-job features for the set of candidate-job pairs as training data for a filtering model. The system then applies the filtering model to additional candidate-job features associated with a candidate and a set of jobs to produce a set of scores, wherein each score represents a likelihood that the candidate perceives a corresponding job as an undesirable recommendation. Finally, the system outputs a subset of the jobs as recommendations to the candidate based on the set of scores.

### BACKGROUND

### Field

The disclosed embodiments relate to user recommendations. More specifically, the disclosed embodiments relate to techniques for filtering recommendations.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows an example filtering model in accordance with the disclosed embodiments.

FIG. 4 shows a flowchart illustrating the processing of data in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for selecting job recommendations. The job recommendations are customized to users that browse and/or search for job postings, users that are identified as job seekers, and/or other types of candidates and potential candidates for jobs. For example, the job recommendations include jobs that are matched to the candidates' education, work experience, skills, level of seniority, location, current titles, and/or past titles.

More specifically, the disclosed embodiments provide a method, apparatus, and system for filtering recommendations of jobs (or other entities) prior to outputting the recommendations to candidates (or other users). An optimization technique is used to generate and/or identify a set of rules that maximize reduction of job dismisses and/or other negative outcomes associated with the recommendations. The optimization technique also includes a constraint that keeps a corresponding reduction in job applications and/or other positive outcomes associated with the recommendations below a threshold.

The rules are used to generate training data for a filtering model that identifies “undesirable” (e.g., harmful, offensive, irrelevant, etc.) recommendations of jobs to candidates. Each rule includes one or more candidate attributes and one or more job attributes. When the candidate attribute(s) are found in a candidate and the job attribute(s) are found in a corresponding job, the candidate-job pair is identified to match the rule, and a label is assigned to the candidate-job pair to indicate that the job is likely to be an undesirable recommendation for the candidate. For example, a rule that includes a candidate attribute of at least five years of work experience and a job attribute with a seniority that is less than entry level (e.g., an internship, training, and/or unpaid position) indicates that below-entry-level jobs are not suitable as recommendations for candidates with more than five years of work experience. As a result, any candidate-job pairs containing candidates with at least five years of experience and jobs that are below entry level are assigned a label that indicates a negative outcome. If a candidate-job pair matches a rule but includes an outcome that conflicts with the label (e.g., a positive outcome for a job that is identified to be a undesirable recommendation for a candidate), the candidate-job pair is removed from the training data, or the label is assigned to the candidate-job pair as an override of the outcome.

Additional training data for the filtering model is obtained from outcomes for additional candidate-job pairs. For example, the candidate-job pairs include candidates and jobs with attributes that don't match any of the rules. When a candidate-job pair has a negative outcome (e.g., a dismissal or ignore of the job by the candidate), the candidate-job pair is assigned a label to indicate that the job is an undesirable recommendation for the candidate. When a candidate-job pair has a positive outcome (e.g., the candidate clicks on, saves, or applies to the job), the candidate-job pair is assigned a different label to indicate that the job is not an undesirable recommendation for the candidate.

The training data is inputted into the filtering model, and the performance of the trained filtering model is validated using the rules. For example, the filtering model is trained to predict labels in the training data given features for the corresponding candidate-job pairs. After training is complete, the filtering model is applied to test and/or validation data to verify that the filtering model has learned all of the rules.

The filtering model is then applied to features for additional candidate-job pairs before recommendations, search results, and/or other output related to the candidates and jobs is generated. For example, the filtering model is used to remove, from a set of potential job recommendations for a candidate, jobs with a high likelihood of being undesirable recommendations for the candidate. Features for remaining jobs in the set are inputted into a machine learning model that predicts the likelihood of a positive outcome (e.g., a job application) between the candidate and each job. Scores from the machine learning model are then used to rank the remaining jobs and select a highest-ranked subset of the remaining jobs as recommendations for the candidate.

By generating and/or sampling training data for the filtering model using rules that maximize reductions in negative outcomes between candidates and jobs, the disclosed embodiments reduce and/or omit noise in the training data that is caused by outcomes that do not correlate with the relevance of the jobs to the candidates. As a result, the filtering model is able to converge more quickly during training than if the filtering model were trained using training data that was not sampled based on the rules. The trained filtering model is also able to identify generalizations and/or specializations to the rules, which can be used to predict additional relevance-based positive and negative outcomes in the corresponding candidate-job pairs. The generation of additional training data from candidate-job pairs that do not match the rules further allows the filtering model to learn additional combinations of candidate and/or job attributes that result in undesirable job recommendations and/or adapt to changes in the attributes or the candidates' behavior over time. Finally, use of the filtering model's output to omit certain jobs from recommendations reduces the likelihood of negative user experiences in interacting with the recommendations and/or increases the relevance and value of the recommendations to the candidates.

In contrast, conventional techniques use hard-coded rules to filter content and/or recommendations. Such rules cannot be generalized, specialized, or adapted to changes in attributes of the recommendations and/or behavior of users for which the recommendations are generated. Instead, content that is filtered by the rules may include relevant or desirable recommendations, and content that is not filtered by the rules may include irrelevant or undesirable recommendations. Users that subsequently interact with the recommendations may thus have negative reactions to the undesirable recommendations and/or miss potential opportunities related to the omitted desirable recommendations. Moreover, the lower quality of the recommendations causes a given user to spend more time and/or effort on interacting with a set of recommendations before the interaction results in a positive outcome. To support the extended interaction time, computer systems involved in generating the recommendations, outputting the recommendations to the user, and/or receiving input related to the recommendations from the user incur additional processing, querying, storage, network, and/or other overhead, which reduces the performance and/or available bandwidth on the computer systems. Consequently, the disclosed embodiments improve computer systems, applications, user experiences, tools, and/or technologies related to user recommendations, training machine learning models, employment, recruiting, and/or hiring.

### Filtering Recommendations

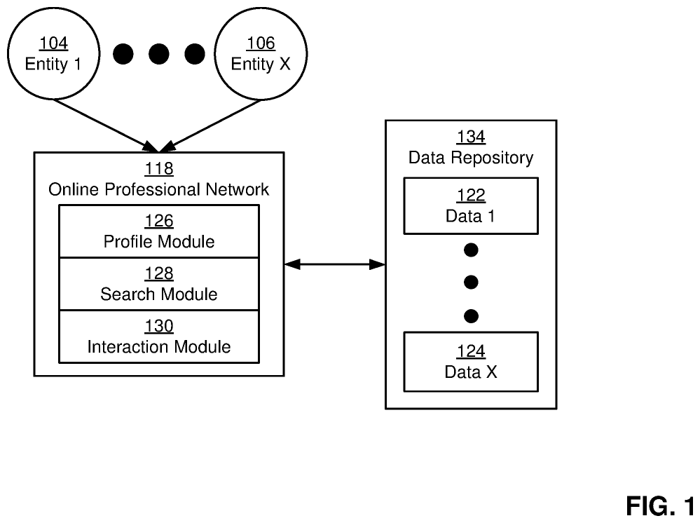

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings related to matching candidates with jobs or opportunities listed within or outside online network 118. In some embodiments, the candidates include users who have viewed, searched for, or applied to jobs, positions, roles, and/or opportunities, within or outside online network 118. The candidates also, or instead, include users and/or members of online network 118 with skills, work experience, and/or other attributes or qualifications that match the corresponding jobs, positions, roles, and/or opportunities.

After the candidates are identified, profile and/or activity data of the candidates are inputted into the machine learning model(s), along with features and/or characteristics of the corresponding opportunities (e.g., required or desired skills, education, experience, industry, title, etc.). The machine learning model(s) output scores representing the strength of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights improve the quality of the candidates, recommendations of opportunities to the candidates, and/or recommendations of candidates for opportunities. Such rankings may also, or instead, increase user activity with online network 118 and/or guide the decisions of candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

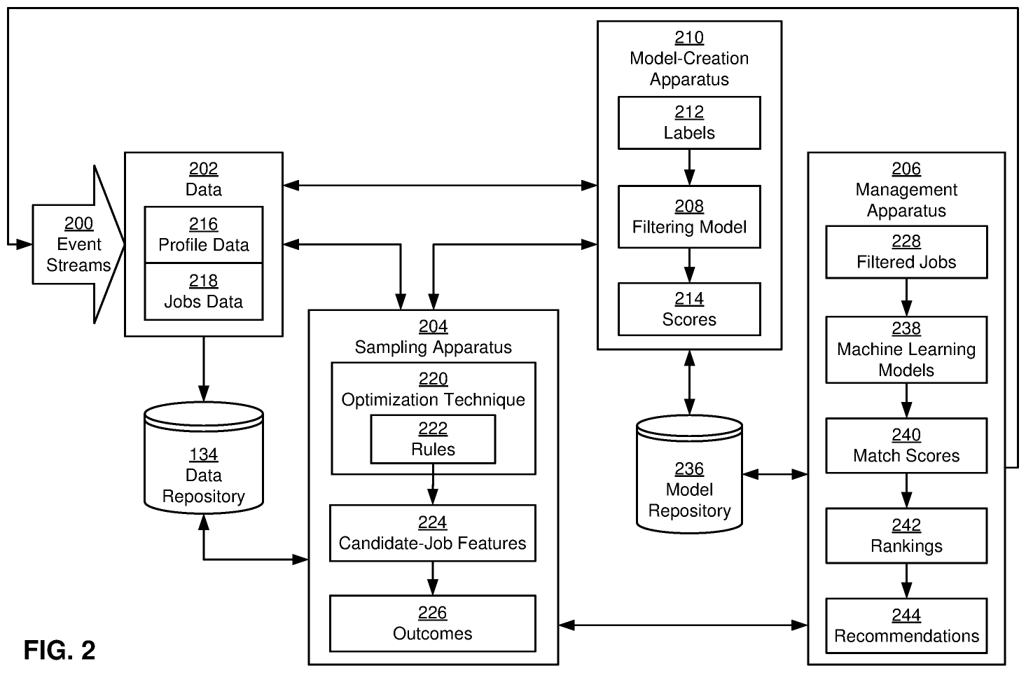

In one or more embodiments, online network 118 includes functionality to improve the timeliness, relevance, and/or accuracy of recommendations related to candidates and/or opportunities. As shown in FIG. 2, data repository 134 and/or another primary data store may be queried for data 202 that includes profile data 216 for members of an online network (e.g., online network 118 of FIG. 1), as well as jobs data 218 for jobs that are listed or described within or outside the online network.

Profile data 216 includes data associated with member profiles in the online network. For example, profile data 216 for an online professional network includes a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 also, or instead, includes a set of groups to which the user belongs, the user's contacts and/or connections, and/or other data related to the user's interaction with the online network.

Attributes of the members from profile data 216 are optionally matched to a number of member segments, with each member segment containing a group of members that share one or more common attributes. For example, member segments in the online network may be defined to include members with the same industry, title, location, and/or language.

Connection information in profile data 216 is optionally combined into a graph, with nodes in the graph representing entities (e.g., users, schools, companies, locations, etc.) in the online network. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online network. For example, jobs data 218 for a given job or job listing may include a declared or inferred title, company, required or desired skills, responsibilities, qualifications, role, location, industry, seniority, salary range, benefits, and/or member segment.

In one or more embodiments, data repository 134 stores data that represents standardized, organized, and/or classified attributes in profile data 216 and/or jobs data 218. For example, skills in profile data 216 and/or jobs data 218 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, user activity 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform such as Apache Kafka (Kafka™ is a registered trademark of the Apache Software Foundation). One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

A sampling apparatus 204 identifies and/or generates a set of rules 222 for filtering recommendations 244. In some embodiments, each rule includes candidate attributes of candidates and job attributes of jobs. When a candidate-job pair includes a candidate with profile data 216 that matches the candidate attributes in a rule and a job with jobs data 218 that matches the job attributes in the same rule, the job is filtered out from job recommendations and/or other job-related output for the candidate.

For example, a rule specifies candidate attributes that include a seniority level of “entry level” and at least five years of work experience. The rule also specifies job attributes that include a seniority level that is less than “entry level” (e.g., one or more seniority levels representing internship, training, and/or unpaid positions) and a company size of less than 10,000 employees. As a result, the rule filters out below-entry-level jobs at companies with less than 10,000 employees from job recommendations for candidates with entry-level seniority at their current positions and at least five years of work experience. In other words, the rule prevents seniority and/or experience mismatches between the candidates and job recommendations shown to the candidates.

In another example, a rule specifies a candidate attribute of a job function that is not equal to “healthcare services” and a job attribute of a job function that is equal to “healthcare services.” The rule thus filters out jobs with healthcare functions from recommendations for candidates that do not have healthcare-related job functions, which prevents mismatches between the candidates' job functions and the job functions of jobs recommended to the candidates.

In one or more embodiments, sampling apparatus 204 uses an optimization technique 220 to obtain rules 222. For example, optimization technique 220 includes a linear programming technique with an optimization objective of maximizing the reduction in negative outcomes 226 (e.g., job dismisses, job ignores, etc.) associated with job recommendations 224. The linear programming technique also includes a constraint of keeping the reduction in positive outcomes 226 (e.g., job applications, job views, etc.) below a threshold proportion (e.g., a percentage reduction). Input into the linear programming technique includes a larger set of rules, which includes rules that are generated based on product requirements and/or domain intuition (e.g., rules that enumerate different combinations of candidate and job seniority levels, work experience, job functions, and/or other attributes). Each rule is associated with a reduction in the proportion of negative outcomes 226 after the rule is applied, as well as a reduction in the proportion of positive outcomes 226 after the rule is applied. The linear programming technique thus selects rules 222 as a subset of the inputted rules that maximizes the reduction in the proportion of negative outcomes while meeting the constraint associated with keeping the reduction in the proportion of positive outcomes below the threshold.

Continuing with the above example, the linear programming technique includes the following representation:

$${arg min}_{𝕀} - 1 * {\sum }_{i} {\sum }_{j} {𝕀}_{ij} * {d}_{ij \\}$$

$$s . t . {\sum }_{j} {𝕀}_{i j} = k ∀ i$$

$${\sum }_{i} {\sum }_{j} {𝕀}_{i j} {a}_{i j} < = {L}_{1}$$

$${\sum }_{j} {𝕀}_{i j} {a}_{ij} < = {L}_{2} ∀ i$$

$$0 <= {𝕀}_{ij} < = 1 ∀ i , j$$

The first line of the above representation specifies the objective function of the linear programming technique, and subsequent lines of the above representation specify constraints of the linear programming technique.

In the above representation, i represents an index for a candidate attribute (e.g., a candidate's seniority level), and j represents an index for a corresponding attribute in rules 222 (e.g., a seniority level specified in a rule). A unique rule index across all attribute values is defined by {i, j}. In addition, [symbol] represents a variable to be learned by the linear programming technique, which controls the rule that is selected for a particular candidate attribute (e.g., candidate seniority level). The number of rules 222 selected by the linear programming technique is set to k for a given candidate attribute.

Continuing with the above representation, dᵢⱼ represents the fraction of negative outcomes (e.g., job dismisses) filtered by a rule indexed by {i, j}, and aᵢⱼ represents the fraction of positive outcomes (e.g., job applications) filtered by the rule. L₁ represents an upper bound on filtering of the positive outcomes by the rules, and L₂ represents an upper bound on filtering of the positive outcomes by the rules, broken down by candidate attributes indexed by i.

After rules 222 are identified and/or selected using optimization technique 220, sampling apparatus 204 uses rules 222 and candidate-job features 224 in data repository 134 to generate training data for a filtering model 208. Candidate-job features 224 include features associated with pairs of candidates and jobs. For example, candidate-job features 224 include a seniority, amount of experience, industry, title, function, company size, and/or another profile attribute of a candidate in a candidate-job pair. Candidate-job features 224 also include the same attributes from a description and/or requirements associated with a job in the candidate-job pair. Candidate-job features 224 also, or instead, include a cosine similarity, cross product, Euclidean distance, and/or another measure of similarity between one or more attributes of the candidate and one or more corresponding attributes of the job.

In one or more embodiments, candidate-job features 224 are generated for candidate-job pairs formed from prior interaction of candidates with jobs. For example, sampling apparatus 204 and/or another component obtain and/or generate candidate-job features 224 for a set of candidate-job pairs, with each candidate-job pair containing a job and a candidate that was shown the job as a recommendation, search result, and/or in another context.

Some or all of the candidate-job pairs associated with candidate-job features 224 additionally include positive and/or negative outcomes 226 associated with the corresponding candidates and jobs. For example, a candidate-job pair has a positive outcome if the candidate applies to and/or otherwise responds positively to a job shown to the candidate and a negative outcome if the candidate rejects and/or otherwise responds negatively to the job. The candidate-job pair is optionally assigned a neutral outcome and/or another type of outcome that is neither strongly positive nor strongly negative when the candidate does not provide explicitly positive or negative feedback regarding the job (e.g., when the candidate ignores or skips the job in a list of recommended jobs or search results).

In one or more embodiments, sampling apparatus 204 generates training data for filtering model 208 by assigning labels 212 to candidate-job features 224. For example, sampling apparatus 204 assigns a positive label to candidate-job features 224 for a candidate-job pair when the candidate-job pair is associated with a positive outcome. Conversely, sampling apparatus 204 assigns a negative label to candidate-job features 224 for a candidate-job pair when the candidate-job pair is associated with a negative outcome.

Sampling apparatus 204 additionally uses rules 222 to filter candidate-job features 224 and labels 212 in training data for filtering model 208, so that labels 212 match outcomes 226 specified in rules 222. As described above, each rule includes one or more candidate attributes of a candidate, as well as one or more job attributes of a job. Because the rule is used to prevent a job from being shown to a candidate when both the candidate's attributes and the job's attributes match the rule, sampling apparatus 204 generates the training data to include candidate-job pairs that match the rule and labels 212 representing negative outcomes for the candidate-job pairs. If a candidate-job pair matches the rule and has a positive outcome, sampling apparatus 204 omits or removes the candidate-job pair (and corresponding outcome) from the training data.

Sampling apparatus 204 also, or instead, assigns or changes labels 212 in the training data to candidate-job features 224 for candidate-job pairs that match one or more rules 222. For example, sampling apparatus 204 identifies a subset of candidate-job pairs that match one or more rules 222 and are associated with outcomes 226 that are neutral or not strongly positive or negative (e.g., candidate-job pairs containing candidates that skip or ignore recommendations of the corresponding jobs). Sampling apparatus 204 changes labels 212 for the identified candidate-job pairs to labels indicating negative outcomes 226 and includes the candidate-job pairs and updated labels 212 in training data for filtering model 208.

Consequently, sampling apparatus 204 includes three groupings of labels 212 in training data for filtering model 208. The first grouping includes labels 212 representing negative outcomes 226 for candidate-job pairs that match one or more rules 222. The first grouping additionally excludes positive labels 212 and corresponding candidate-job features 224 for candidate-job pairs that match one or more rules 222 to reduce noisy and/or bad samples from the training data.

The second grouping includes updated labels 212 representing negative outcomes 226, which are assigned to candidate-job pairs that match one or more rules 222 and have neutral (or not strongly positive or negative) outcomes 226. By assigning negative labels 212 to ambiguous or neutral outcomes for the candidate-job pairs, sampling apparatus 204 increases the proportion of negative labels 212 in the training data, which mitigates label bias caused by a significantly higher proportion of positive outcomes 226 than negative outcomes 226 in the candidate-job pairs.

The third grouping includes labels 212 assigned to candidate-job pairs that do not match any rules 222. Within the third grouping, candidate-job features 224 for a given candidate-job pair are assigned a label representing a positive outcome when the candidate-job pair is associated with a positive outcome and a different label representing a negative outcome when the candidate-pair is associated with a negative outcome. Training data in the third grouping thus includes candidate-job features 224 and labels 212 that reflect candidate preferences and/or attitudes toward jobs that are not codified in existing rules 222.

A model-creation apparatus 210 uses training data from sampling apparatus 204 to create and/or update filtering model 208. For example, model-creation apparatus 210 inputs candidate-job features 224 and labels 212 for candidate-job pairs selected by sampling apparatus 204 into a gradient-boosted tree and/or another type of machine learning model used as filtering model 208. Model-creation apparatus 210 then uses a training technique and/or one or more hyperparameters to update parameters values of filtering model 208 so that scores 214 outputted by filtering model 208 better reflect labels 212 for the corresponding candidate-job features 224.

In one or more embodiments, each score generated by filtering model 208 from a set of candidate-job features 224 for a candidate-job pair represents the likelihood that the candidate perceives the job as an undesirable (e.g., irrelevant, offensive, harmful, etc.) recommendation or has a negative reaction to the job. For example, filtering model 208 outputs scores 214 ranging from 0 to 1. A higher score indicates a higher likelihood of an undesirable job recommendation, and a lower score indicates a lower likelihood of an undesirable job recommendation. As a result, model-creation apparatus 210 trains filtering model 208 to output a score that is close to 1 when the candidate-job pair has a label value indicating a negative outcome and a score that is close to 0 when the candidate-job pair has a label value indicating a positive outcome. Alternatively, a higher score indicates a higher likelihood of a desirable (e.g., relevant, useful, helpful, etc.) job recommendation, and a lower score indicates a lower likelihood of a desirable job recommendation. In this case, model-creation apparatus 210 trains filtering model 208 to output a score that is close to 1 when the candidate-job pair has a label value indicating a positive outcome and a score that is close to 0 when the candidate-job pair has a label value indicating a negative outcome.

In some embodiments, labels 212 indicating negative outcomes for candidate-job features 224 in the training data are weighted based on the severity of the mismatch between the corresponding candidates and jobs. For example, a candidate-job pair with a very large seniority gap (e.g., a director-level candidate and an intern-level job) is assigned a label value that is more strongly indicative of an undesirable recommendation or outcome than a candidate-job pair with a smaller seniority gap (e.g., a director-level candidate and a senior-level job). In turn, model-creation apparatus 210 trains filtering model 208 to output scores 214 that reflect the magnitudes of the corresponding labels 212.

Before training of filtering model 208 is complete, model-creation apparatus 210 verifies that filtering model 208 has learned all rules 222. For example, model-creation apparatus 210 obtains and/or creates a test or validation data set containing candidate-job features 224 for candidate-job pairs that match different subsets and/or combinations of rules 222. Model-creation apparatus 210 uses filtering model 208 to generate scores 214 from the test or validation data set and verifies that the outputted scores 214 are indicative of labels 212 and/or negative outcomes 226 for the candidate-job pairs.

After filtering model 208 is created and/or updated, model-creation apparatus 210 stores parameters of filtering model 208 in a model repository 236. For example, model-creation apparatus 210 may replace old values of the parameters in model repository 236 with the updated parameters, or model-creation apparatus 210 may store the updated parameters separately from the old values (e.g., by storing each set of parameters with a different version number of filtering model 208).

A management apparatus 206 obtains a representation of filtering model 208 from model-creation apparatus 210, model repository 236, and/or another source. Next, management apparatus 206 applies filtering model 208 to additional candidate-job features 224 for a given candidate and a set of jobs to generate a set of filtered jobs 228 as potential recommendations 244 for the candidate.

For example, management apparatus 206 retrieves the initial set of jobs as jobs that match one or more attributes in the candidate's profile data 216 and/or the candidate's career interests (e.g., the candidate's preferred title, function, industry, seniority, location, company size, etc.). Management apparatus 206 applies filtering model 208 to candidate-job features 224 for the candidate and each of the jobs to produce scores 214 between the candidate and the set of jobs. Like the selection and/or generation of rules 222 by sampling apparatus 204, management apparatus 206 selects and/or obtains a threshold for the scores as a score value outputted by filtering model 208 that maximizes filtering of negative outcomes 226 from the set of jobs, subject to the constraint that filtering of positive outcomes 226 from the set of jobs stays within a threshold proportion of percentage. Management apparatus 206 then selects filtered jobs 228 as a subset of the initial set of jobs that meet the threshold (e.g., scores with less than a certain likelihood of being undesirable recommendations for the candidate or higher than a certain likelihood of being desirable recommendations for the candidate).

Management apparatus 206 then generates and/or selects job recommendations 244 for the candidate from the set of filtered jobs 228. As shown in FIG. 2, management apparatus 206 uses machine learning models 238 to generate recommendations 244 from features associated with filtered jobs 228. In some embodiments, management apparatus 206 generates recommendations 244 as search results of the candidate's job search, search results of a recruiter's search for qualified candidates for a job, job recommendations that are displayed and/or transmitted to the candidate, and/or within other contexts related to job seeking, recruiting, careers, and/or hiring.

In one or more embodiments, machine learning models 238 generate output related to the compatibility of the candidate with filtered jobs 228. For example, machine learning models 238 generate predictions representing the likelihood of a positive outcome between the candidate and each job (e.g., the candidate applying to the job, given the candidate's impression of the job; the candidate receiving a response to the job application; adding of the candidate to a hiring pipeline for the job; interviewing of the candidate for the job; and/or hiring of the candidate for the job).

In one or more embodiments, machine learning models 238 include a global version, a set of personalized versions, and a set of job-specific versions. The global version includes a single machine learning model that tracks the behavior or preferences of all candidates with respect to all jobs in data repository 134. Each personalized version of the model is customized to the individual behavior or preferences of a corresponding candidate with respect to certain job features (e.g., a candidate's personal preference for jobs that match the candidate's skills). Each job-specific model identifies the relevance or attraction of a corresponding job to certain candidate features (e.g., a job's likelihood of attracting candidates that prefer skill matches).

The output of the global version, a personalized version for the candidate, and/or a job-specific version for a given job is combined to generate a match score (e.g., match scores 240) representing the predicted probability of the candidate applying to the job, clicking on the job, and/or otherwise responding positively to an impression or recommendation of the job. For example, scores generated by the global version, personalized version, and job-specific version are aggregated into a sum and/or weighted sum that is used as the candidate's predicted probability of responding positively to the job after viewing the job.

Features inputted into the global, personalized, and/or job-specific versions of machine learning models 238 include, but are not limited to, some or all candidate-job features 224 inputted into filtering model 208. For example, the features include the candidate's title, function, skills, education, seniority, industry, location, and/or other professional and/or demographic attributes. The features also include job features such as the job's title, industry, function, seniority, desired or required skill and experience, salary range, and/or location.

The features further include cross products, cosine similarities, statistics, and/or other combinations, aggregations, scaling, and/or transformations of the candidate's and/or job's attributes. More specifically, the features include cosine similarities between standardized versions of all of the candidate's skills and all of the job's skills. The features also, or instead, include similarities between one or more candidate titles associated with the candidate and each job in filtered jobs 228. The features also, or instead, include other measures of similarity and/or compatibility between one attribute of the candidate and another attribute of the job (e.g., a match percentage between a candidate's “Java” skill and a job's “C++” skill).

To generate recommendations 244, management apparatus 206 retrieves, from model repository 236, model-creation apparatus 210, and/or another data source, the latest parameters of one or more machine learning models 238 that generate predictions related to a candidate's compatibility with a job, the likelihood of a positive outcome between the candidate and job, and/or the candidate's strength or quality with respect to requirements or qualifications of the job. Next, management apparatus 206 inputs features for a given candidate and filtered jobs 228 for the candidate into machine learning models 238 to generate a set of match scores 240 between the candidate and filtered jobs 228. For example, management apparatus 206 produces match scores 240 in an offline, batch-processing, and/or periodic basis (e.g., from batches of features in data repository 134), or management apparatus 206 generates match scores 240 in an online, nearline, and/or on-demand basis (e.g., when a candidate logs in to the online network, views a job, performs a search, applies for a job, and/or performs another action).

In one or more embodiments, match scores 240 include representations of predictions from machine learning models 238. For example, management apparatus 206 applies a logistic regression model, deep learning model, support vector machine, tree-based model, ensemble model, and/or another type of machine learning model to features for a candidate-job pair to produce a score from 0 to 1 representing the likelihood of a positive outcome associated with the candidate and job.

Management apparatus 206 then generates rankings 242 of filtered jobs 228 by the corresponding match scores 240. For example, management apparatus 206 may rank filtered jobs 228 for the candidate by descending predicted likelihood of positively responding to the jobs.

Finally, management apparatus 206 outputs some or all jobs in rankings 242 as recommendations 244 to the corresponding candidates. For example, management apparatus 206 displays some or all filtered jobs 228 that have been ranked by descending match scores 240 from machine learning models 238 within a job search tool, email, notification, message, and/or another communication containing job recommendations 244 to the candidate. Subsequent responses to recommendations 244 may, in turn, be used to generate events that are fed back into the system and used to update features, filtering model 208, machine learning models 238, and/or recommendations 244.

By generating and/or sampling training data for filtering model 208 using rules 222 that maximize reductions in negative outcomes 226 between candidates and jobs, the system of FIG. 2 reduces and/or omits noise in the training data that is caused by outcomes 226 that do not correlate with the relevance of the jobs to the candidates. As a result, filtering model 208 is able to converge more quickly during training than if filtering model 208 were trained using training data that was not sampled based on the rules. The trained filtering model 208 is also able to identify generalizations and/or specializations to rules 222, which can be used to predict additional relevance-based positive and negative outcomes 226 in the corresponding candidate-job pairs. The generation of additional training data from candidate-job pairs that do not match rules 222 further allows filtering model 208 to learn additional combinations of candidate and/or job attributes that result in undesirable job recommendations 244 and/or adapt to changes in the attributes or the candidates' behavior over time. Finally, use of the filtering model's output to omit certain jobs from recommendations 244 reduces the likelihood of negative user experiences in interacting with recommendations 244 and/or increases the relevance and value of recommendations 244 to the candidates.

In contrast, conventional techniques use hard-coded rules to filter content and/or recommendations. Such rules cannot be generalized, specialized, or adapted to changes in attributes of the recommendations and/or behavior of users for which the recommendations are generated. Instead, content that is filtered by the rules may include relevant or desirable recommendations, and content that is not filtered by the rules may include irrelevant or undesirable recommendations. Users that subsequently interact with the recommendations may thus have negative reactions to the undesirable recommendations and/or miss potential opportunities related to the omitted desirable recommendations. Moreover, the lower quality of the recommendations causes a given user to spend more time and/or effort on interacting with a set of recommendations before the interaction results in a positive outcome. To support the extended interaction time, computer systems involved in generating the recommendations, outputting the recommendations to the user, and/or receiving input related to the recommendations from the user incur additional processing, querying, storage, network, and/or other overhead, which reduces the performance and/or available bandwidth on the computer systems. Consequently, the disclosed embodiments improve computer systems, applications, user experiences, tools, and/or technologies related to user recommendations, training machine learning models, employment, recruiting, and/or hiring.

Those skilled in the art will appreciate that the system of FIG. 2 may be implemented in a variety of ways. First, sampling apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Sampling apparatus 204, model-creation apparatus 210, and management apparatus 206 may additionally be implemented together and/or separately by one or more hardware and/or software components and/or layers.

Second, a number of models and/or techniques may be used to generate scores 214, match scores 240, and/or rankings 242. For example, the functionality of filtering model 208 and/or machine learning models 238 may be provided by regression models, artificial neural networks, support vector machines, decision trees, random forests, gradient boosted trees, naïve Bayes classifiers, Bayesian networks, clustering techniques, collaborative filtering techniques, deep learning models, hierarchical models, and/or ensemble models. In another example, management apparatus 206 uses scores 214 outputted by filtering model 208 as additional features that are inputted into machine learning models 238 and/or a multi-objective optimization technique that generates rankings 242 instead of as hard filters for the corresponding jobs. In turn, the multi-objective optimization technique and/or machine learning models 238 are able to generate match scores 240 that account for the likelihoods of undesirable recommendations 244 in the corresponding jobs, which improves the quality and/or relevance of the resulting recommendations 244 that are generated and outputted based on match scores 240.

The retraining or execution of filtering model 208 and/or machine learning models 238 may also be performed on an offline, online, and/or on-demand basis to accommodate requirements or limitations associated with the processing, performance, or scalability of the system and/or the availability of features used to train the machine learning model. Multiple versions of filtering model 208 and/or a machine learning model may further be adapted to different subsets of candidates and/or jobs (e.g., different member segments), or the same machine learning model may be used to generate scores 214 and/or match scores 240 for all candidates and/or jobs. Similarly, the functionality of machine learning models 238 may be merged into a single machine learning model that performs a single round of scoring and ranking of job selections 226 for a candidate and/or separated out into more than two machine learning models that perform multiple rounds of scoring, filtering, and/or ranking of filtered jobs 227 according to different sets of features and/or criteria.

Third, the system of FIG. 2 may be adapted to different types of candidates, opportunities, features, and/or recommendations 244. For example, filtering model 208 and machine learning models 238 may be used to generate scores 214, match scores 240, rankings 242, and/or recommendations 244 related to awards, publications, patents, group memberships, profile summaries, academic positions, artistic or musical roles, fields of study, fellowships, scholarships, competitions, hobbies, online dating matches, goods, services, movies, and/or other entities that can matched to user behavior and/or preferences.

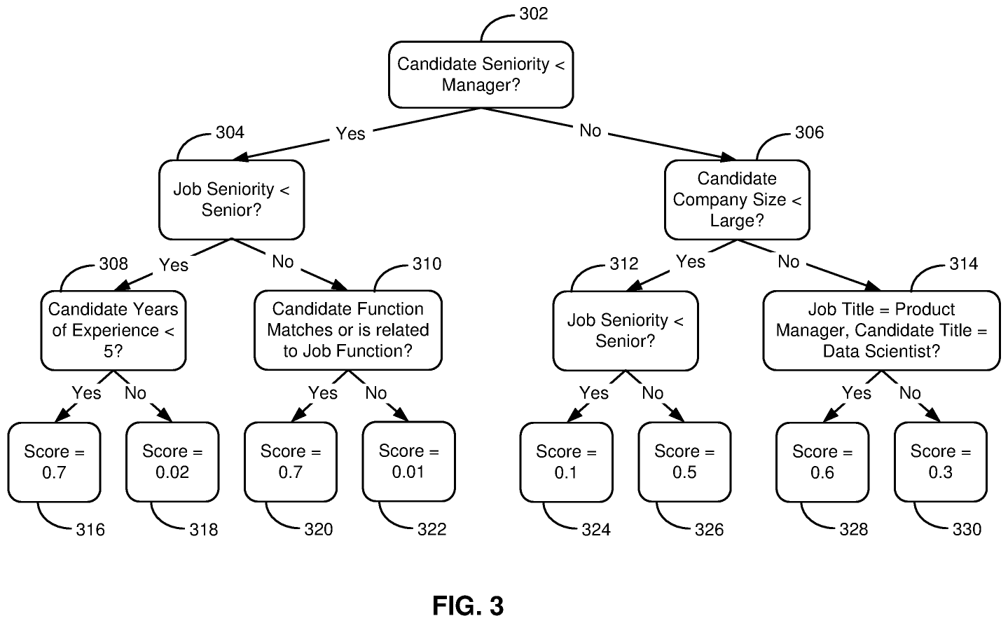

FIG. 3 shows an example filtering model (e.g., filtering model 208 of FIG. 2) in accordance with the disclosed embodiments. As shown in FIG. 3, the filtering model includes a tree structure. For example, the filtering model includes a decision tree, random forest, gradient boosted tree, and/or another type of tree-based model.

The filtering model includes a number of nodes 302-330. Non-leaf nodes 302-314 represent decisions related to candidate-job pairs, which are connected to child nodes via edges representing outcomes of the decisions. Leaf nodes 316-330 in the model represent output scores of the model; in turn, a given path from the root node 302 to a leaf node represents a “rule” or “pattern” learned by the filtering model in classifying jobs in candidate-job pairs as desirable or undesirable recommendations for the corresponding candidates.

More specifically, the root node 302 includes a comparison of a candidate's seniority level to a manager level. If the candidate's seniority level is less than manager level, the filtering model leads to a child node 304; if the candidate's seniority level is at least manager level, the filtering model leads to a different child node 306.

Node 304 compares the seniority of a job to a senior level. If the job's seniority is less than senior level, the filtering model leads to a child node 308 of node 304. If the job's seniority less at least senior level, the filtering model leads to a different child node 310 of node 304.

Node 308 compares the candidate's years of experience with a value of 5. If the candidate has less than five years of experience, the filtering model leads to a leaf node 316 that assigns a score of 0.7 to the candidate-job pair. If the candidate has at least five years of experience, the filtering model leads to a leaf node 318 that assigns a score of 0.02 to the candidate-job pair.

Node 310 compares the candidate's function with the job's function. If the candidate's function matches or is related to the job's function (e.g., if the candidate has more than a threshold likelihood of transitioning to the job, given the candidate's function and the job's function), the filtering model leads to a leaf node 320 that assigns a score of 0.7 to the candidate-job pair. If the candidate's function neither matches nor is related to the job's function, the filtering model leads to another leaf node 322 that assigns a score of 0.01 to the candidate-job pair.

Node 306 compares the candidate's company size to that of a large company. If the candidate's company size is smaller than that of a large company, the filtering model leads to a child node 312 of node 306. If the candidate's company size is at least that of a large company, the filtering model leads to a different child node 314 of node 306.

Node 312 compares the job's seniority level to a senior level. If the job's seniority level is less than the senior level, the filtering model leads to a leaf node 324 that assigns a score of 0.1 to the candidate-job pair. If the job's seniority level is at least senior level, the filtering model leads to a different leaf node 326 that assigns a score of 0.5 to the candidate-job pair.

Node 314 compares the job's title to “Product Manager” and the candidate's title to “Data Scientist.” If the job's title matches or is equivalent to “Product Manager” and the candidate's title matches or is equivalent to “Data Scientist,” the filtering model leads to a leaf node 328 that assigns a score of 0.6 to the candidate-job pair. If the job's title does not match or is not equivalent to “Product Manager” or the candidate's title does not match or is not equivalent to “Data Scientist,” the filtering model leads to a different leaf node 330 that assigns a score of 0.3 to the candidate-job pair.

The score associated with each leaf node (e.g., nodes 316-330) reflects the likelihood that a candidate-job pair with attributes that lead to the leaf node contains a job that is a desirable (or undesirable) recommendation for the corresponding candidate. For example, low scores in nodes 318, 322, 324, and 330 indicate that candidate-job pairs with attributes that lead to those nodes are more likely to result in negative outcomes when the jobs are recommended to the candidates. Conversely, higher scores in nodes 316, 320, 326, and 328 indicate that candidate-job pairs with attributes that lead to those nodes are less likely to result in negative outcomes when the jobs are recommended to the candidates.

As mentioned above, the filtering model generalizes and/or specializes a set of rules (e.g., rules 222 of FIG. 2) that are used to produce training data for the filtering model. For example, the path containing nodes 302, 304, and 308 customizes a rule related to seniority-based mismatches between candidates and jobs. More specifically, the path indicates that a job with a seniority level that is below senior can be recommended to a candidate with a seniority level that is below manager when the candidate has less than five years of work experience.

At the same time, the filtering model identifies additional patterns and/or rules that can be used to classify jobs as desirable or undesirable recommendations. For example, the path containing nodes 302, 306, and 314 represents a new rule specifying that a job related to product management can be recommended to a candidate that is a data science manager

A threshold can be applied to scores generated using the leaf nodes 316-330 to filter a subset of jobs from potential recommendations for the corresponding candidates. For example, a threshold of 0.6 for scores outputted by the filtering model causes jobs in candidate-job pairs with attributes that lead to leaf nodes 318, 322, 324, 326, and 330 to be removed from potential recommendations for the corresponding candidates.

Scores generated by the filtering model are also, or instead, included in features that are used to generate and/or rank jobs as recommendations for the corresponding candidates. For example, the scores are inputted with additional features into one or more machine learning models (e.g., machine learning models 238 of FIG. 2) that predict the likelihood that a candidate has a positive response to a recommended job. As a result, the machine learning model(s) are able to account for the output of the filtering model in generating the predicted likelihood, which improves the accuracy of the models' predictions.

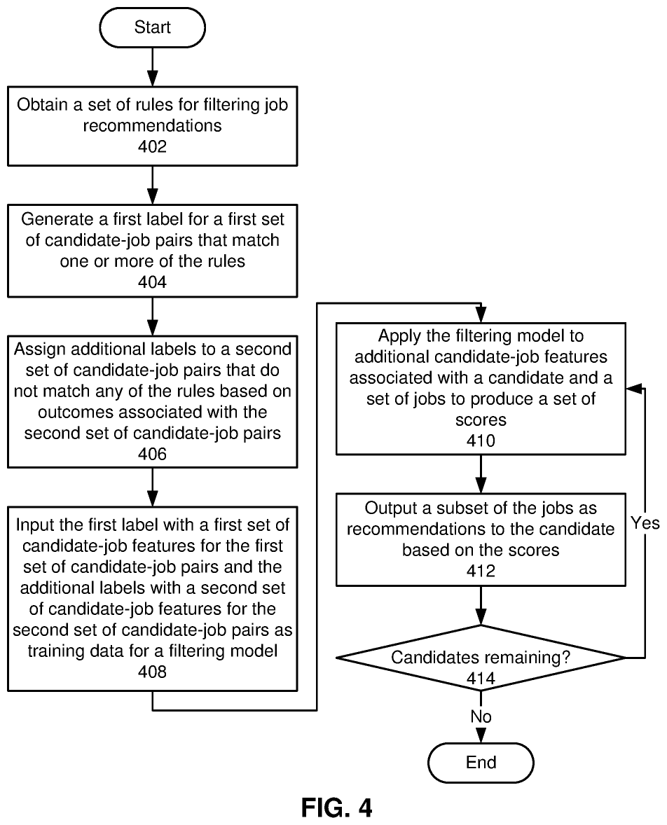

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of rules for filtering job recommendations is obtained (operation 402). For example, an optimization technique such as linear programming is applied to a larger set of rules to select the set of rules. The optimization technique includes an optimization objective of maximizing the reduction in negative outcomes associated with the job recommendations and a constraint of keeping a reduction in positive outcomes associated with the job recommendations below a threshold. Each rule produced by the optimization technique includes one or more candidate attributes of a candidate and one or more job attributes of jobs to filter from recommendations for the candidate.

Next, a first label for a first set of candidate-job pairs that match one or more of the rules is generated (operation 404). For example, the first label indicates that a job in a candidate-job pair to which the first label is assigned is an undesirable recommendation for the candidate in the same candidate-job pair.

In some instances, a candidate-job pair that matches one or more rules is added to the first set of candidate-job pairs by changing the label for the candidate-job pair to the first label. For example, the first label is used to replace a missing label, neutral label, and/or other label that was previously assigned to a candidate-job pair that matches one or more rules. In other instances, the first label is used to select and/or filter the first set of candidate-job pairs. For example, one or more candidate-job pairs are removed or excluded from the first set of candidate-job pairs when outcomes associated with the candidate-job pair(s) (e.g., a candidate applying for a job that would be filtered by a rule) do not match the negative outcome represented by the first label.

Additional labels are assigned to a second set of candidate-job pairs that do not match any of the rules based on outcomes associated with the second set of candidate-job pairs (operation 406). For example, the second set of candidate-job pairs include combinations of candidate and job attributes that are not found in any of the rules. Outcomes associated with the second set of candidate-job pairs are received after outputting recommendations of jobs in the second set of candidate-job pairs to candidates in the second set of candidate-job pairs. Within the second set of candidate-job pairs, the first label is assigned to candidate-job pairs associated with negative outcomes (e.g., dismisses of job recommendations by the corresponding candidates), and a second label with a different value is assigned to candidate-job pairs associated with positive outcomes (e.g., applies by candidates to recommended and/or outputted jobs).

The first label is inputted with a first set of candidate-job features for the first set of candidate job pairs, along with the additional labels and a second set of candidate-job features for the second set of candidate-job pairs, as training data for a filtering model (operation 408). For example, the filtering model is trained to predict the labels based on candidate-job features that include, but are not limited to, a seniority, company size, amount of experience, industry, title, function, and/or a match between a candidate attribute and a corresponding job attribute.

The filtering model is then applied to additional candidate-job features associated with a candidate and a set of jobs to produce a set of scores (operation 410). For example, the filtering model generates a score between the candidate and each of the jobs. The score represents the likelihood that the candidate perceives the corresponding job as an undesirable recommendation or responds negatively to the job as a recommendation.

Finally, a subset of the jobs is outputted as recommendations to the candidate based on the scores (operation 412). For example, the subset of jobs is identified as having scores from the filtering model that meet a threshold. Features for the subset of jobs are inputted into a machine learning model, and the machine learning model outputs match scores representing likelihoods of positive outcomes between the candidate and the subset of the jobs. Recommendations of some or all of the identified jobs are generated by ranking the jobs by descending score and/or by applying a threshold to the scores.

In another example, scores from the filtering model are inputted with additional features for the entire set of jobs into a machine learning model, and the machine learning model outputs match scores representing likelihoods of positive outcomes between the candidate and the set of jobs. A ranking of the jobs is generated by descending match score, and at least a portion of the ranking as job recommendations to the candidate.

Operations 410-412 are repeated for remaining candidates (operation 414). For example, the filtering model is used to generate scores that filter and/or otherwise modify job recommendations to candidates that are currently interacting with job-related modules of an online system, candidates that are identified as job seekers, and/or other types of users with an explicit or inferred interest in jobs.

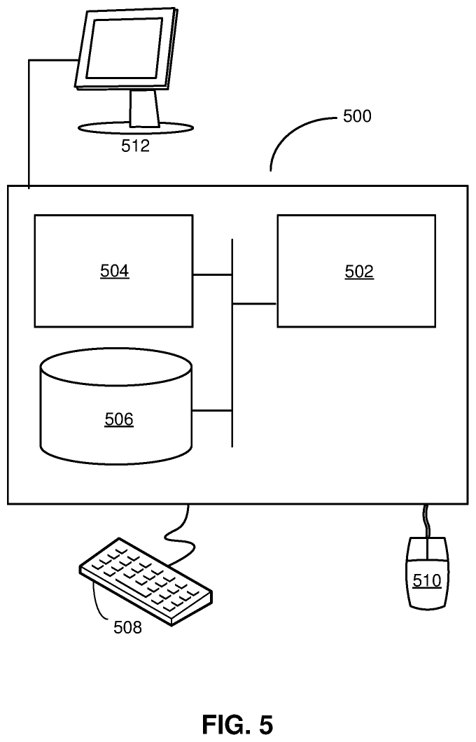

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes a sampling apparatus, a model-creation apparatus, and a management apparatus, one or more of which may alternatively be termed or implemented as a module, mechanism, or other type of system component. The sampling apparatus obtains a set of rules for filtering job recommendations, which are selected to maximize a reduction in negative outcomes associated with the job recommendations. Next, the sampling apparatus generates a label for a set of candidate-job pairs that match one or more of the rules. The model-creation apparatus inputs the label with a set of candidate-job features for the set of candidate-job pairs as training data for a filtering model. The management apparatus then applies the filtering model to additional candidate-job features associated with a candidate and a set of jobs to produce a set of scores, wherein each score represents a likelihood that the candidate perceives a corresponding job as an undesirable recommendation. Finally, the management apparatus outputs a subset of the jobs as recommendations to the candidate based on the set of scores.

In addition, one or more components of computer system 500 may be remotely located and connected to the other components over a network. Portions of the present embodiments (e.g., sampling apparatus, model-creation apparatus, management apparatus, data repository, model repository, online network, etc.) may also be located on different nodes of a distributed system that implements the embodiments. For example, the present embodiments may be implemented using a cloud computing system that generates and/or filters job recommendations for a set of remote users.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of rules for filtering job recommendations, wherein the set of rules is selected to maximize a reduction in negative outcomes associated with the job recommendations;
generating, by the one or more computer systems, a first label for a first set of candidate-job pairs that match one or more rules in the set of rules;
inputting, by the one or more computer systems, the first label with a first set of candidate-job features for the first set of candidate-job pairs as training data for a filtering model;
applying, by the one or more computer systems, the filtering model to additional candidate-job features associated with a candidate and a set of jobs to produce a set of scores, wherein each score in the set of scores represents a likelihood that the candidate perceives a corresponding job as an undesirable recommendation; and
outputting a subset of the jobs as recommendations to the candidate based on the set of scores.

2. The method of claim 1, further comprising:
assigning additional labels to a second set of candidate-job pairs that do not match the set of rules based on outcomes associated with the second set of candidate-job pairs; and
inputting the additional labels with a second set of candidate-job features for the second set of candidate-job pairs as additional training data for the machine learning model.

3. The method of claim 2, wherein assigning the additional labels to the second set of candidate-job pairs based on the outcomes associated with the second set of candidate-job pairs comprises:
receiving the outcomes after outputting jobs in the second set of candidate-job pairs to corresponding candidates in the second set of candidate-job pairs.

4. The method of claim 1, wherein obtaining the set of rules for filtering the job recommendations comprises:
applying an optimization technique to a larger set of rules and outcomes associated with the larger set of rules to select the set of rules that maximizes the reduction in the negative outcomes.

5. The method of claim 4, wherein the optimization technique comprises a constraint of keeping a reduction in positive outcomes associated with the job recommendations below a threshold.

6. The method of claim 5, wherein the positive outcomes comprise at least one of:
an impression of a first job; and
an application to a second job.

7. The method of claim 1, wherein outputting the subset of the jobs as recommendations to the candidate based on the scores comprises:
identifying the subset of the jobs as having scores that meet a threshold;
inputting features for the subset of the jobs into a machine learning model;
receiving, as output from the machine learning model, match scores representing likelihoods of positive outcomes between the candidate and the subset of the jobs; and
generating the recommendations for the candidate based on the match scores.

8. The method of claim 1, wherein outputting the subset of the jobs as recommendations to the candidate based on the scores comprises:
inputting the scores and features for the set of jobs into a machine learning model;
receiving, as output from the machine learning model, match scores representing likelihoods of positive outcomes between the candidate and the set of jobs;
generating a ranking of the set of jobs according to the match scores; and
outputting at least a portion of the ranking as the recommendations to the candidate.

9. The method of claim 1, wherein generating the first label for the first set of candidate-job pairs that match the one or more rules comprises at least one of:
changing a label for a first candidate-job pair that matches the one or more rules to the first label; and
removing a second candidate-job pair from the first set of candidate-job pairs based on a mismatch between an outcome associated with the second candidate-job pair and the first label.

10. The method of claim 1, wherein the negative outcomes comprise at least one of:
a dismissal of a first job; and
ignoring a second job.

11. The method of claim 1, wherein the additional candidate-job features comprise at least one of:
a seniority;
a company size;
an amount of experience;
an industry;
a title;
a function; and
a match between an attribute of the candidate and a corresponding attribute of a job.

12. The method of claim 1, wherein the set of rules comprises at least one of:
one or more candidate attributes of candidates; and
one or more job attributes of jobs to filter from the job recommendations for the candidates.

13. The method of claim 1, wherein the filtering model comprises a gradient boosted tree.

14. A system, comprising:
one or more processors; and
memory storing instructions that, when executed by the one or more processors, cause the system to:
obtain a set of rules for filtering job recommendations, wherein the set of rules is selected to maximize a reduction in negative outcomes associated with the job recommendations;
generate a first label for a first set of candidate-job pairs that match one or more rules in the set of rules;
input the first label with a first set of candidate-job features for the first set of candidate-job pairs as training data for a filtering model;
apply the filtering model to additional candidate-job features associated with a candidate and a set of jobs to produce a set of scores, wherein each score in the set of scores represents a likelihood that the candidate perceives a corresponding job as an undesirable recommendation; and
output a subset of the jobs as recommendations to the candidate based on the set of scores.

15. The system of claim 14, wherein the memory further stores instructions that, when executed by the one or more processors, cause the system to:
assign additional labels to a second set of candidate-job pairs that do not match the set of rules based on outcomes associated with the second set of candidate-job pairs; and
input the additional labels with a second set of candidate-job features for the second set of candidate-job pairs as additional training data for the machine learning model.

16. The system of claim 14, wherein obtaining the set of rules for filtering the job recommendations comprises:
applying an optimization technique to a larger set of rules and outcomes associated with the larger set of rules to select the set of rules that maximizes the reduction in the negative outcomes.

17. The system of claim 14, wherein outputting the subset of the jobs as recommendations to the candidate based on the scores comprises:
identifying the subset of the jobs as having scores that meet a threshold;
inputting features for the subset of the jobs into a machine learning model;
receiving, as output from the machine learning model, match scores representing likelihoods of positive outcomes between the candidate and the subset of the jobs; and
generating the recommendations for the candidate based on the match scores.

18. The system of claim 14, wherein outputting the subset of the jobs as recommendations to the candidate based on the scores comprises:
inputting the scores and features for the set of jobs into a machine learning model;
receiving, as output from the machine learning model, match scores representing likelihoods of positive outcomes between the candidate and the set of jobs;
generating a ranking of the set of jobs according to the match scores; and
outputting at least a portion of the ranking as the recommendations to the candidate.

19. The system of claim 14, wherein generating the first label for the first set of candidate-job pairs that match the one or more rules comprises at least one of:
changing a label for a first candidate-job pair that matches the one or more rules to the first label; and
removing a second candidate-job pair from the first set of candidate-job pairs based on a mismatch between an outcome associated with the second candidate-job pair and the first label.

20. A non-transitory computer-readable storage medium storing instructions that when executed by a computer cause the computer to perform a method, the method comprising:
obtaining a set of rules for filtering job recommendations, wherein the set of rules is selected to maximize a reduction in negative outcomes associated with the job recommendations;
generating a first label for a first set of candidate-job pairs that match one or more rules in the set of rules;
inputting the first label with a first set of candidate-job features for the first set of candidate-job pairs as training data for a filtering model;
applying the filtering model to additional candidate-job features associated with a candidate and a set of jobs to produce a set of scores, wherein each score in the set of scores represents a likelihood that the candidate perceives a corresponding job as an undesirable recommendation; and
outputting a subset of the jobs as recommendations to the candidate based on the set of scores.
